(19) United States
(12) Patent Application Publication
(10) Pub. No.: US 2013/0216003 A1
(43) Pub. Date: Aug. 22, 2013

(54) RESETTABLE VOLTAGE CONTROLLED OSCILLATORS (VCOs) FOR CLOCK AND DATA RECOVERY (CDR) CIRCUITS, AND RELATED SYSTEMS AND METHODS

(71) Applicants: Jingcheng Zhuang, San Diego, CA (US); Nam V. Dang, San Diego, CA (US)

(72) Inventors: Jingcheng Zhuang, San Diego, CA (US); Nam V. Dang, San Diego, CA (US)

(73) Assignee: QUALCOMM Incorporated, San Diego, CA (US)

(21) Appl. No.: 13/465,057

(22) Filed: May 7, 2012

Related U.S. Application Data
(60) Provisional application No. 61/599,692, filed on Feb. 16, 2012.

(51) Int. Cl. H04L 25/02

(52) U.S. Cl. CPC H04L 25/02
USPC 375/316

(57) ABSTRACT

Clock and data recovery (CDR) circuits and resettable voltage controlled oscillators (VCOs) are disclosed. In one embodiment, the CDR circuit includes a sampler configured to receive a data stream in a data path and sample the data stream. However, a clock signal of the data stream needs to be recovered to sample the data stream since the data stream may not be accompanied by the clock signal. To recover the clock signal from the data stream, the CDR circuit may have a resettable VCO configured to generate a clock output. The sampler and the resettable VCO may be operably associated so that the sampler samples the data stream in the data path based on the clock output. The resettable VCO can be reset to adjust a clock phase of the clock output and help reduce sampling errors resulting from drift of the clock output and/or the data stream.

### PRIORITY APPLICATION

The present application claims priority to U.S. Provisional Patent Application Ser. No. 61/599,692 entitled “RESETTABLE VOLTAGE CONTROLLED OSCILLATORS (VCOs) FOR CLOCK DATA RECOVERY (CDR), AND RELATED CDR CIRCUITS, SYSTEMS, AND METHODS” filed on Feb. 16, 2012, which is hereby incorporated herein by reference in its entirety.

### BACKGROUND

I. Field of the Disclosure

The technology of the disclosure relates to clock and data recovery (CDR) circuits that recover a clock signal from data stream for sampling the data stream.

II. Background

A data stream is sometimes transmitted without an accompanying clock. Communicating the data stream without an accompanying clock signal reduces the bandwidth required to transmit the data stream. However, to recover bits from the data stream, the data stream is typically sampled by a sampler that needs a timing reference to sample the data stream appropriately. One way of providing this timing reference is to provide a clock and data recovery (CDR) circuit that recovers a clock signal from the data stream. CDR is the process of extracting and reconstructing a clock signal from a data stream unaccompanied by a clock signal. The generated clock signal is provided to the sampler to control when the data stream is sampled and recover data bits in the data stream.

FIG. 1 illustrates an example of a CDR circuit 10. In this regard, the CDR circuit 10 includes a data path 12 that carries a data stream 14. To recover a clock signal from this data stream 14, the CDR circuit 10 includes a clock path 16. The clock path 16 includes an edge detector 18 that detects an edge in the data stream 14 (i.e., a transition in bit values). In response to detection of the edge in the data stream 14, the edge detector 18 generates a reset pulse 20 to a gated voltage controlled oscillator (VCO) 22 in order to generate a clock output 24. The gated VCO 22 is reset on edge detection to avoid clock phase drift of the clock output 24. The clock output 24 generated by the gated VCO 22 is provided to a clock buffer 26 that provides a buffered clock output 28. The buffered clock output 28 is used by a sampler 30 in the data path 12 to control the time of the sampling of the data stream 14. In the data path 12, a tunable delay 32 is provided between the data input and the sampler 30. The tunable delay 32 phase shifts the data stream 14 relative to the clock output 24 so the sampler 30 samples the data at an optimal phase (e.g., the maximum opening of an eye pattern for the data stream 14). The amount of delay provided by the tunable delay 32 is controlled by a delay control code 34.

Providing the tunable delay 32 in the data path 12 of the CDR circuit 10 requires additional hardware and die area, and can increase power consumption.

### SUMMARY OF THE DISCLOSURE

Embodiments disclosed in the detailed description include clock and data recovery (CDR) circuits and resettable voltage controlled oscillators (VCOs). The CDR circuits and resettable VCOs disclosed herein do not require a tunable delay circuit in a data path. To recover bits communicated within a data stream, one embodiment of the CDR circuit includes a sampler configured to receive a data stream in a data path and sample the data stream. A clock signal recovered from the data stream is used by the sampler to sample the data stream. To recover the clock signal from the data stream, the CDR circuit includes a resettable VCO configured to generate a clock output. The sampler and the resettable VCO may be operably associated so that the sampler samples the data stream in the data path based on the clock output. To reduce errors during sampling, the resettable VCO is configured to phase shift the clock output so that the data stream and the clock output are appropriately phase aligned. In this manner, a tunable delay circuit is not needed in the data path to phase align the clock output and the data stream.

In one embodiment of the resettable VCO, the resettable VCO can be reset to phase shift the clock output and help reduce sampling errors resulting from drift in the CDR circuit. More particularly, the clock output generated by the resettable VCO has a clock phase. As the phase of the data stream and/or the clock phase of the clock output can experience drift, the resettable VCO may be configured to receive a phase control input indicative of a phase setting for the clock phase of the clock output. As a result of edge detection in the data stream, the resettable VCO adjusts the clock phase of the clock output based on the phase control input. As such, the clock phase of the clock output can be realigned with the phase of the data stream thereby reducing sampling errors caused by drift.

One embodiment of a CDR circuit has a clock path that includes the resettable VCO. The clock path of the CDR circuit also has an edge detector configured to receive the data stream. Upon detection of an edge in the data stream, the edge detector generates a reset pulse. The resettable VCO is configured to adjust the clock phase of the clock output based on the phase control input as a result of the reset pulse. In this manner, the clock output is phase shifted and a tunable delay circuit is not needed in the data path.

In another embodiment, a method for generating a clock output from a data stream in a CDR circuit is provided. The method allows for the phase alignment of the clock output and the data stream without tunably delaying the data stream in a data path. The method includes generating the clock output having a clock phase. The method also includes receiving a phase control input indicative of a phase setting for the clock phase of the clock output. To align the clock phase of the clock output with the phase of the data stream, the method also includes adjusting the clock phase of the clock output based on the phase control input as a result of edge detection in the data stream.

In yet another embodiment, a computer readable medium is provided. The computer readable medium stores computer executable instructions that may be implemented by a processor-based resettable VCO. The computer executable instructions are configured to cause the processor-based resettable VCO to generate a clock output having a clock phase. By implementing the computer executable instructions, the processor-based resettable VCO also is configured to receive a phase control input indicative of a phase setting for the clock phase. As a result of edge detection, the computer executable instructions cause the processor-based resettable VCO to adjust the clock phase of the clock output based on the phase control input. By executing the computer executable instructions stored on the computer readable medium, the processor-based resettable VCO eliminates the need for a tunable delay circuit in a data path to phase align the clock output and the data stream.

### BRIEF DESCRIPTION OF THE FIGURES

FIG. 1 is a block diagram of an exemplary clock and data recovery (CDR) circuit with a tunable delay including a data path and a gated voltage controlled oscillator (VCO) included in a clock path that generates a clock output to a sampler to control sampling of the data stream;

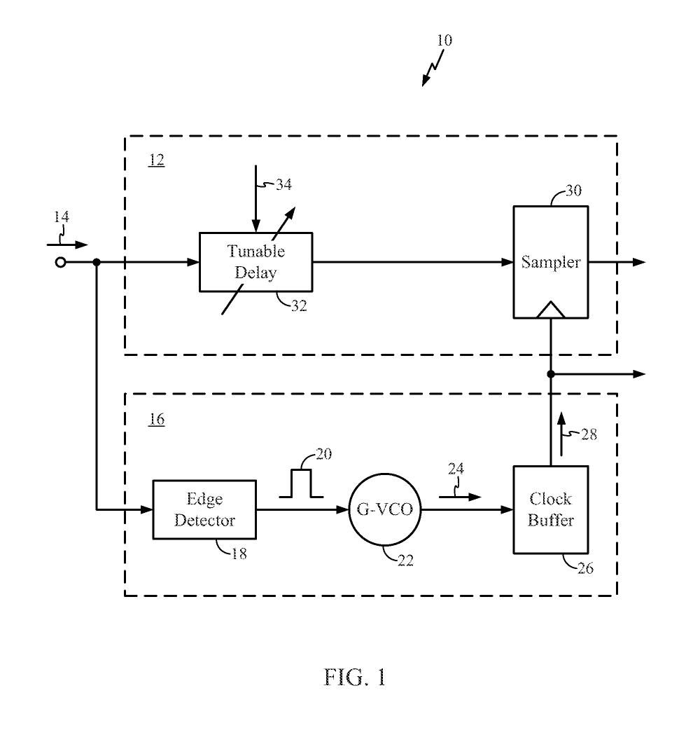

FIG. 2 is a block diagram of an exemplary CDR circuit including a data path that carries a data stream, and including a clock path having an exemplary resettable VCO configured to generate a clock output in the clock path for controlling sampling of the data stream in the data path;

FIG. 3 is a block diagram of another exemplary CDR circuit including a data path that carries a data stream, and including a clock path having another exemplary resettable VCO configured to generate a clock output in the clock path for controlling sampling of the data stream in the data path;

FIG. 4A is a diagram of internal circuitry of an exemplary resettable VCO having a plurality of delay stages;

FIG. 4B is a timing diagram illustrating exemplary differential outputs of the delay stages in the resettable VCO shown in FIG. 4A;

FIG. 4C is a timing diagram illustrating an exemplary reset pulse and phase-shifted clock outputs that can be provided by the resettable VCO in FIG. 4A;

FIG. 4D is an exemplary circuit diagram of a delay stage in the resettable VCO of FIG. 4A;

FIG. 5 is an exemplary circuit diagram of the phase-shift set up circuit in the clock path of the exemplary CDR circuit in FIG. 3, wherein the phase-shifting set up circuit is configured to generate a gated phase control input for the resettable VCO in FIG. 4A; and

FIG. 6 is a block diagram of an exemplary processor-based system that can include the CDR circuits of the present disclosure.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

A data stream communicated to another device may be unaccompanied by a clock signal. Less bandwidth is required to transmit the data stream if an accompanying clock signal is not provided. Nevertheless, the data stream may need to be sampled to recover bits in the received data stream. Accordingly, a timing reference is needed to sample the data stream. One method of providing a timing reference is to recover a clock signal from the data stream by providing a clock and data recover (CDR) circuit.

Embodiments disclosed in the detailed description include clock and data recovery (CDR) circuits and resettable voltage controlled oscillators (VCOs). The CDR circuits and resettable VCOs disclosed herein do not require a tunable delay circuit in a data path. To recover bits communicated within a data stream, one embodiment of the CDR circuit includes a sampler configured to receive a data stream in a data path and sample the data stream. A clock signal recovered from the data stream is used by the sampler to sample the data stream. To recover the clock signal from the data stream, the CDR circuit includes a resettable VCO configured to generate a clock output. The sampler and the resettable VCO may be operably associated so that the sampler samples the data stream in the data path based on the clock output. To reduce errors during sampling, the resettable VCO is configured to phase shift the clock output so that the data stream and the clock output are appropriately phase aligned. In this manner, a tunable delay circuit is not needed in the data path to phase align the clock output and the data stream.

In one embodiment of the resettable VCO, the resettable VCO can be reset to phase shift the clock output and help reduce sampling errors resulting from drift in the CDR circuit. More particularly, the clock output generated by the resettable VCO has a clock phase. As the phase of the data stream and/or the clock phase of the clock output can experience drift, the resettable VCO may be configured to receive a phase control input indicative of a phase setting for the clock phase of the clock output. As a result of edge detection in the data stream, the resettable VCO adjusts the clock phase of the clock output based on the phase control input. As such, the clock phase of the clock output can be realigned with the phase of the data stream thereby reducing sampling errors caused by drift.

One embodiment of a CDR circuit has a clock path that includes the resettable VCO. The clock path of the CDR circuit also has an edge detector configured to receive the data stream. Upon detection of an edge in the data stream, the edge detector generates a reset pulse. The resettable VCO is configured to adjust the clock phase of the clock output based on the phase control input as result of the reset pulse. In this manner, the clock output is phase shifted and a tunable delay circuit is not needed in the data path.

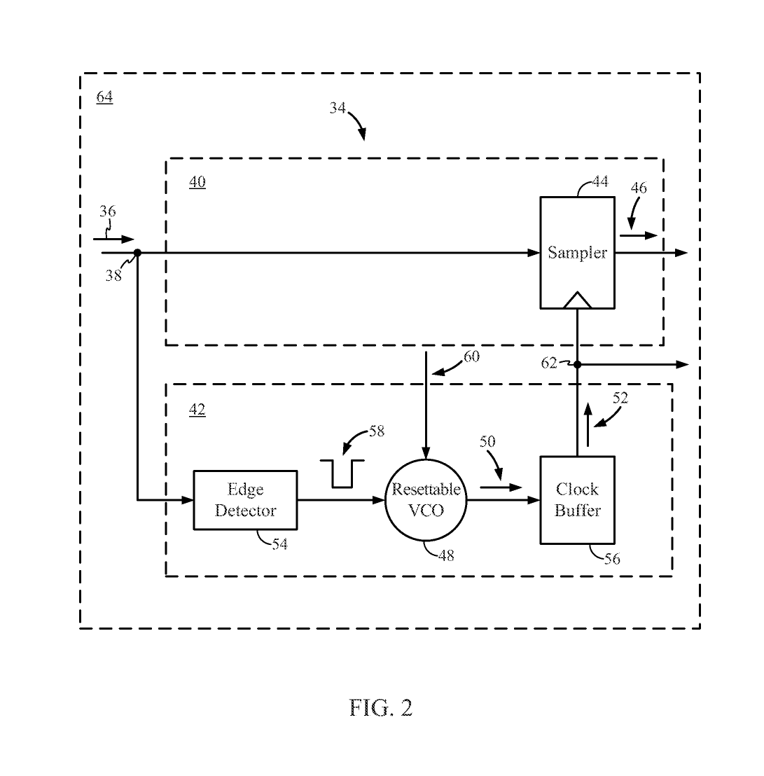

In this regard, FIG. 2 illustrates one embodiment of a CDR circuit 34 configured to recover a clock signal from a data stream 36 to be provided to a sampler to recover bits from the data stream 36. The CDR circuit 34 receives the data stream 36 at an input node 38. The input node 38 is operably associated with a data path 40 and a clock path 42 in the CDR circuit 34. The data stream 36 at the input node 38 is carried along the data path 40. To recover the bits from the data stream 36, the CDR circuit 34 includes a sampler 44 in the data path 40. The sampler 44 is configured to receive and sample the data stream 36 in the data path 40. The sampler 44 generates a data output 46 indicative of bits recovered from the data stream 36. In one embodiment, the data output 46 has an non-return to zero (NRZ) signal format. For instance, if the sample obtained by the sampler 44 is above a threshold voltage level, this indicates a logical “1”. The sampler 44 generates the data output 46 as having a high voltage level to indicate that the bit recovered from the data stream 36 is a “1”. If the sample obtained from the data stream 36 is below the threshold voltage level, no pulse is generated in the data output 46 to indicate that the bit recovered from the data stream 36 is a “0”. In this manner, the sampler 44 generates the data output 46 representing the recovered bits from the data stream 36.

However, the sampler 44 has to sample the data stream 36 at an appropriate sampling phase. Since the data stream 36 may be received unaccompanied by a clock signal, the CDR circuit 34 in FIG. 2 also includes the clock path 42. The clock path 42 includes a resettable VCO 48 configured to generate a clock output 50 having a clock phase as the recovered clock signal from the data stream 36. The sampler 44 in the data path 40 samples the data stream 36 based on the clock output 50. In this embodiment, the sampler 44 receives a buffered clock output 52 based on the clock output 50. Accordingly, the sampler 44 samples the data stream 36 based on the clock output 50 generated by the resettable VCO 48.

To reduce sampling errors in the data output 46, the clock phase of the clock output 50 is controlled according to the phase of the data stream 36. An eye pattern of the data stream 36 may be utilized to determine the optimum phase for sampling the data stream 36. The eye pattern of the data stream 36 provides traces of different symbols employed by the modulation technique of the data stream 36. (The traces may show the signal levels of the different symbols when received by the sampler 44.) Additionally, the traces may be plotted over a single symbol period so that differences in the signal levels of the different symbols can be readily observed from the eye diagram. In this particular example, the bit rate is assumed to be equal to the symbol rate. Alternative embodiments may implement schemes where different symbols represent groupings of one or more bits in the data stream 36.

The symbol period may be determined from a symbol rate of the modulation technique, which is typically an integer multiple of a bit rate of the data stream 36. In this example, the symbol rate is equal to the bit rate and thus the symbol period is equal to 1/bit rate. A maximum opening of the eye pattern indicates when sampling the data stream 36 is least likely to produce sampling errors. The maximum opening of the eye pattern is temporally positioned at a particular time (or at particular times) during the symbol period. This particular time (or particular times) corresponds to an optimum phase (or optimum phases) for sampling the data stream 36.

With continuing reference to FIG. 2, the resettable VCO 48 may initially align the clock phase of the clock output 50, (and thus the clock phase of the buffered clock output 52) so the sampler 44 samples the data stream 36 at or close to optimum data phases. Even so, the clock output 50 can drift thereby modifying the phase alignment between the data stream 36 and the clock output 50, which may increase the error rate of the data output 46. In this regard, the resettable VCO 48 is configured to adjust the clock phase of the clock output 50 as a result of edge detection in the data stream 36. This helps maintain sampling of the data stream 36 by the sampler 44 at or close to the optimum phase (or optimum phases) and reduces the error rate of the data output 46 generated by the sampler 44. As the data stream 36 may be employed using any type of communication format, different embodiments of the resettable VCO 48 may be employed to phase align the clock output 50 and the data stream 36 depending on the particular communication format of the data stream 36.

In this particular embodiment, the clock path 42 is also coupled to the input node 38 so as to receive the data stream 36 and recover the clock signal from the data stream 36. The clock path 42 includes an edge detector 54, the resettable VCO 48, and a clock buffer 56. The edge detector 54 is configured to receive the data stream 36 and generate a reset pulse 58 upon detection of an edge in the data stream 36. The resettable VCO 48 is coupled to the edge detector 54 and is configured to generate the clock output 50 having the clock phase. In particular, the resettable VCO 48 generates the clock output 50 such that the clock output 50 has a clock frequency based on the bit rate of the data stream 36. Since the CDR circuit 34 may be configured to operate with the data stream 36 communicated over a particular communication channel, the bit rate of the data stream 36 may be inherently known. On the other hand, the bit rate of the data stream 36 may be determined by other devices upstream or downstream from the CDR circuit 34, and the resettable VCO 48 may be adjusted to generate the clock output 50 with a clock frequency based on the bit rate. In one example, the clock frequency of the clock output 50 is approximately double the bit rate so that the sampler 44 samples the data stream 36 according to the Nyquist sampling rate. Alternatively, the resettable VCO 48 may be responsive to the timing of the reset pulses 58 from the edge detector 54 (or from another edge detector) in order to generate the clock output 50 with a clock frequency based on the bit rate of the data stream 36.

The edge detector 54 may generate the reset pulse 58 upon detection of every edge in the data stream 36 or, alternatively, every n^{th} number of edges in the data stream 36. This may depend on the particular characteristics of the data stream 36 and the desired sampling technique to be employed by the sampler 44. For example, if the data stream 36 is a NRZ signal, each bit in the data stream 36 may not have complimentary edges. This occurs in an NRZ signal when consecutive bits have the same bit value. Accordingly, in one embodiment, the edge detector 54 generates the reset pulse 58 at every edge of the data stream 36. In other words, reset pulses 58 are generated at both positive and negative transition edges, at only positive edges, or at only negative edges. This allows the resettable VCO 48 to provide phase alignment after every edge or at certain edges. For example, reset pulses 58 may be generated for every positive transition edges in the data stream 36. Alternatively, reset pulses 58 may be generated for every negative transition edge in the data stream 36.

The NRZ signal format is often utilized in data transmission since an NRZ signal with the same bit rate as an RZ signal requires less bandwidth. Different applications may employ the NRZ format, the RZ format, and any other format to represent bits within the data stream 36. While the specific embodiments discussed herein employ a data stream having an NRZ signal format, other embodiments of the CDR circuit 34 and the components of the CDR circuit 34 may be configured to recover clock signals from data streams having any other format. With regard to the edge detector 54 shown in FIG. 2, the data stream 36 is presumed to have an NRZ signal format and the edge detector 54 is configured to generate reset pulses 58 in response to every edge of the data stream 36. Alternatively, the edge detector 54 may be configured to generate the reset pulses 58 for only rising or falling edges. Still other embodiments of the CDR circuit 34 may be designed to generate reset pulses for data streams with other signal formats and for selected edges within the data stream in accordance with the signal format.

To prevent or correct drift of the data stream 36 and/or the clock output 50, the resettable VCO 48 may be configured to receive a phase control input 60 indicative of a phase setting for the clock phase of the clock output 50. The resettable VCO 48 adjusts the clock phase of the clock output 50 based on the phase control input 60. Furthermore, the resettable VCO 48 is configured to adjust the clock phase of the clock output 50 as a result of edge detection in the data stream 36. As such, the adjustments to the clock phase of the clock output 50 may be provided in response to the reset pulse 58. In this particular embodiment, the resettable VCO 48 operates in a reset mode in response to the reset pulse 58 from the edge detector 54. In the reset mode, the resettable VCO 48 resets so that the clock phase of the clock output 50 is provided in accordance to the phase setting indicated by the phase control input 60 upon release of the reset pulse 58. Once the reset pulse is released, the resettable VCO 48 operates in an oscillation mode where the resettable VCO 48 is simply configured to generate the clock output 50.

It should be noted that the CDR circuit 34 of FIG. 2 does not include a tunable delay circuit in the data path 40 to adjust the phases of the data stream 36. Rather, the clock path 42 shifts the clock output 50 to align the clock phase of the clock output 50 with the data stream 36. By utilizing the resettable VCO 48 to provide phase alignment, the hardware, die area, and power consumption of the CDR circuit 34 may be reduced.

During the oscillation mode, the resettable VCO 48 shown in FIG. 2 is unresponsive to the phase control input 60 regardless of whether the phase control input 60 is being received. However, when the reset pulse 58 is received, the resettable VCO 48 operates in the reset mode so the clock phase of the clock output 50 can be adjusted in accordance with the phase setting indicated by the phase control input 60. This allows the embodiment of the resettable VCO 48 in FIG. 2 to provide phase adjustments of the clock output 50 relative to the current phase of the data stream 36, as indicated by the reset pulse 58.

The clock path 42 and the data path 40 are coupled to the sampler 44. The sampler 44 samples the data stream 36 in the data path 40 based on the clock output 50. The sampler 44 may sample the data stream 36 based on the clock output 50 by directly receiving the clock output 50, by indirectly receiving the clock output 50, or by receiving another type of clock signal generated in accordance with the clock output 50. In this embodiment, the clock buffer 56 is coupled between the resettable VCO 48 and the sampler 44. The clock buffer 56 is configured to receive the clock output 50 from the resettable VCO 48 and provide a buffered clock output 52 to the sampler 44. In this example, the sampler 44 indirectly receives the clock output 50 since the buffered clock output 52 is a buffered version of the clock output 50. Additionally, the buffered clock output 52 is also independently transmitted from an output node 62 of the CDR circuit 34 so that the buffered clock output 52 can be utilized by downstream circuits coupled to the CDR circuit 34. In one embodiment, the sampler 44 generates the data output 46 as an NRZ signal. Accordingly, while the bit rate of the data output 46 and the data stream 36 may be equal, the frequency components of the data stream 36 and the data output 46 may be different. The data output 46 may be sent from the sampler 44 to downstream circuitry for further processing.

With continuing reference to FIG. 2, the phase control input 60 is utilized in order to correct misalignments due to drift between the clock phase of the clock output 50, the clock phase of the buffered clock output 52, and the data stream 36. In this regard, the phase setting indicated by the phase control input 60 realigns the clock phase of the clock output 50 to control sampling by the sampler 44 at or close to the optimum phase of the data stream 36, if possible.

As shown in FIG. 2, the CDR circuit 34 has been integrated into a semiconductor die 64. As such, the data path 40, the clock path 42, the sampler 44, the edge detector 54, the resettable VCO 48, and the clock buffer 56, are circuits that have been integrated into the semiconductor die 64. Alternatively, one or more of the components of the CDR circuit 34 may be provided on a separate semiconductor die(s). For instance, alternative embodiments of a resettable VCO may be implemented using general purpose computer hardware, such as a microprocessor. These processor-based resettable VCOs may be provided on a separate semiconductor die and are operable to implement computer-executable instructions. The computer-executable instructions cause the processor-based resettable VCOs to generate the clock output 50, receive the phase control input 60, and adjust the clock phase of the clock output 50 based on the phase control input 60 as a result of edge detection in the data stream 36. The processor-based resettable VCOs may thus be used in embodiments of the CDR circuit analogous to the CDR circuit 34 shown in FIG. 2. Computer-executable instructions may also be provided for other processor-based resettable VCOs configured to operate with other CDR circuits within the scope of this disclosure.

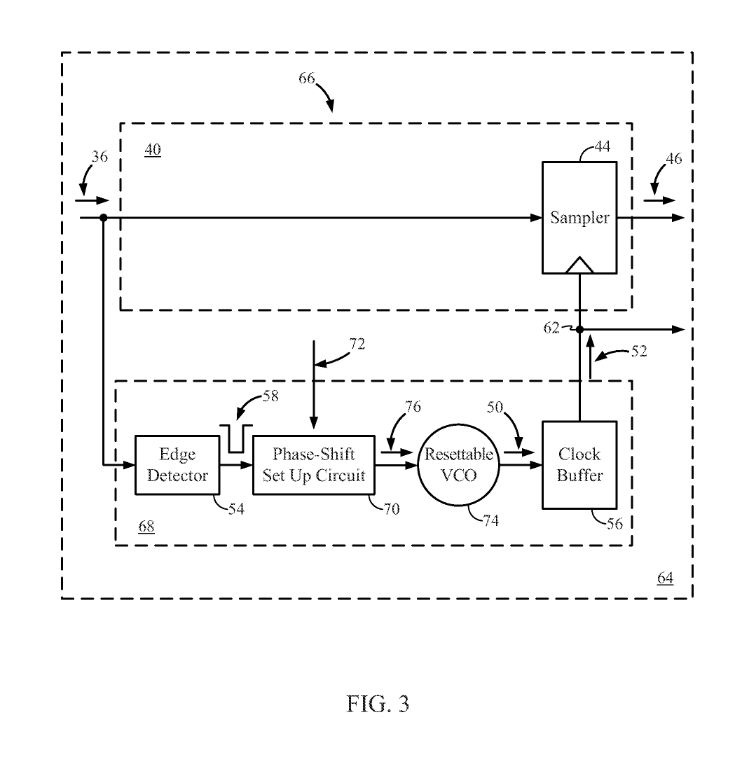

FIG. 3 illustrates another exemplary CDR circuit 66 in accordance with this disclosure. The CDR circuit 66 is also operable to recover bits and a clock signal from the data stream 36. However, a different exemplary clock path 68 is used in the CDR circuit 66 to control sampling of the sampler 44. Unlike the clock path 42 shown in FIG. 2, the clock path 68 includes a phase-shift setup circuit 70 configured to receive the reset pulse 58 from the edge detector 54 and a preliminary phase control input 72. Additionally, another exemplary resettable VCO 74 is provided in the clock path 68 to generate the clock output 50.

The phase-shift setup circuit 70 in FIG. 3 generates a phase control input 76 based on the preliminary phase control input 72 and the reset pulse 58. More specifically, the phase-shift setup circuit 70 gates the preliminary phase control input 72 with the reset pulse 58. Since the phase-shift setup circuit 70 gates the preliminary phase control input 72 with the reset pulse 58, the phase control input 76 is gated by the reset pulse 58. In this manner, the phase-shift setup circuit 70 generates the phase control input 76 as a gated phase control input. As explained in further detail below, one embodiment of the preliminary phase control input 72 may be provided as a preliminary phase control code and one embodiment of the phase control input 76 may be provided as a gated phase control code.

With continuing reference to FIG. 3, the resettable VCO 74 is configured to receive the phase control input 76 from the phase-shift setup circuit 70 and adjust the clock phase of the clock output 50 based on the phase control input. The phase control input 76 is indicative of a phase setting for the clock phase of the clock output 50. Since the phase control input 76 received by the resettable VCO 74 is gated by the reset pulse 58, the resettable VCO 74 is configured to adjust the clock phase as a result of edge detection in the data stream 36. In this manner, the clock output 50 (and thus also the buffered clock output 52) can be aligned so that the data stream 36 is sampled at or near the optimum data phase.

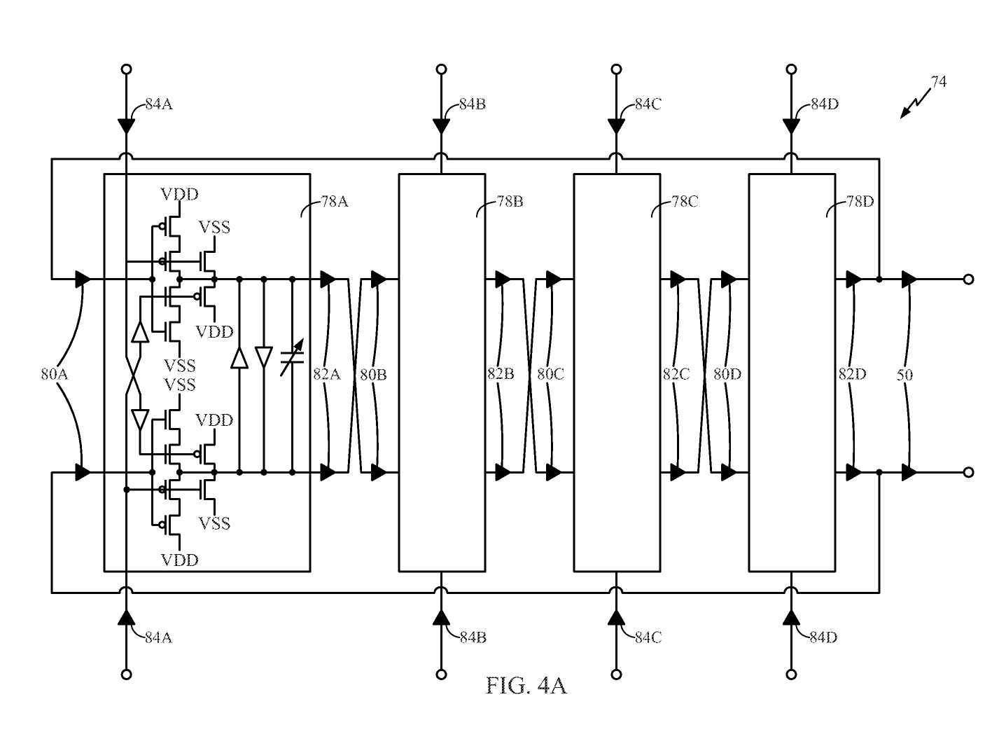

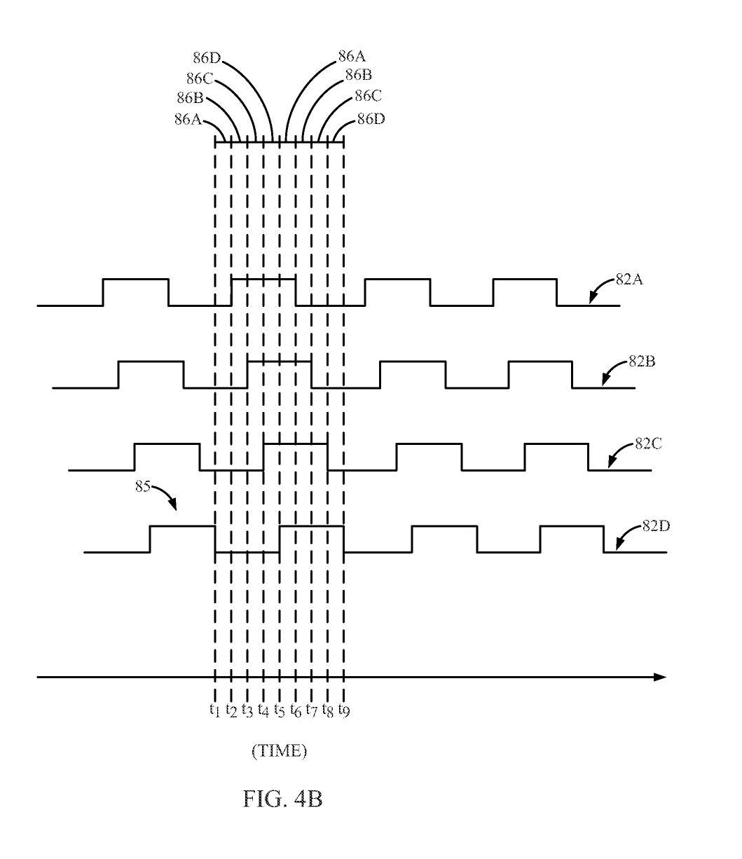

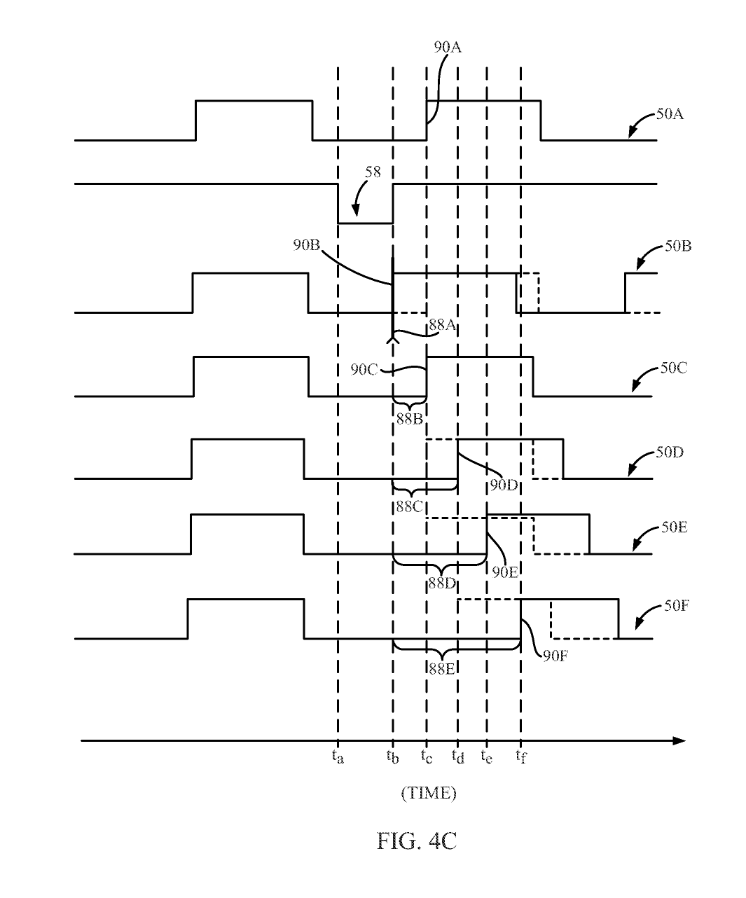

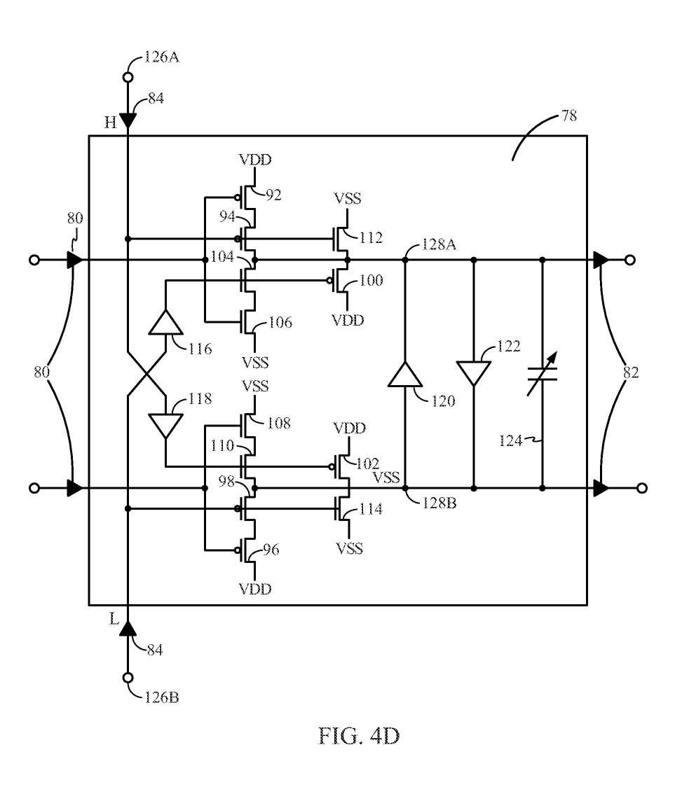

FIG. 4A is an exemplary circuit diagram of the resettable VCO 74 shown in FIG. 3. The resettable VCO 74 has a plurality of delay stages (referred to generically as element 78 and individually as elements 78A-78D) configured to generate the clock output 50. In particular, each delay stage 78 is configured to receive a differential input (referred to generically as element 80 and individually as elements 80A-80D) and generate a differential output (referred to generically as element 82 and individually as elements 82A-82D). The resettable VCO 74 of FIG. 4A has four delay stages 78A-78D. However, as will become apparent to one of ordinary skill in the art in light of this disclosure, alternative embodiments of the resettable VCO 74 may have any number of delay stages 78.

The delay stages 78 are collectively configured in an oscillation loop, which allows the delay stages 78 to generate the clock output 50. Each delay stage 78 is programmable to operate in an oscillation mode and a reset mode. The resettable VCO 74 operates in the oscillation mode when not receiving the phase control input 76 (shown in FIG. 3) and the differential inputs 80 determine the differential outputs 82 in the oscillation mode. However, when the phase control input 76 is being received by the resettable VCO 74 shown in FIG. 4A, the resettable VCO 74 operates in the reset mode and the differential outputs 82 are determined by a series of codes (referred to generically as element 84 and individually as elements 84A-84D). The series of codes 84 shown in FIG. 4A make up one embodiment of the phase control input 76 shown in FIG. 3. In this embodiment, the phase control input 76 is presumed to be a gated phase control code gated by the reset pulse 58 and indicative of edge detection in the data stream 36. Unlike the oscillation mode, the code 84 received by the delay stage 78 determines the differential output 82 in the reset mode, not the differential input 80. The phase setting indicated by the gated phase control code may represent a phase delay.

In the particular embodiment illustrated in FIG. 4A, the resettable VCO 74 includes an initial delay stage 78A, a first intermediary delay stage 78B, a second intermediary delay stage 78C, and a final delay stage 78D. The initial delay stage 78A is configured to receive an initial differential input 80A and generate an initial differential output 82A. Analogously, the first intermediary delay stage 78B is configured to receive a first intermediary differential input 80B and generate a first intermediary differential output 82B. The second intermediary delay stage 78C is configured to receive a second intermediary differential input 80C and generate a second intermediary differential output 82C. Finally, the final delay stage 78D is configured to receive a final differential input 80D and generate a final differential output 82D. The final differential output 82D generated by the final delay stage 78D is the clock output 50.

To form the oscillation loop, the initial delay stage 78A is configured to receive the clock output 50 as the initial differential input 80A. As the final differential output 82D is fed back to the initial delay stage 78A, the initial delay stage 78A generates the initial differential output 82A in response to feedback received during the oscillation mode. The final delay stage 78D is configured to receive the final differential input 80D, which is based on the initial differential output 82A. From this, the final delay stage 78D generates the final differential output 82D.

All that is required to provide oscillation during the oscillation mode is that the clock output 50 fed back to the resettable VCO 74 results in an inversion of the clock output 50 by the resettable VCO 74. In this example, the final differential output 82D is the clock output 50 and the clock output 50 is fed back to the initial delay stage 78A as the initial differential input 80A. The inversion of the final differential output 82D results in the inversion of the initial differential input 80A which again results in the inversion of the final differential output 82D. As these inversions are continually repeated due to feedback, the oscillation of the clock output 50 is provided. The clock frequency of the clock output 50 is determined by a total propagation delay of the resettable VCO 74. More specifically, the total propagation delay of the resettable VCO 74 may be equal to about half of a clock period since inversion of the clock output 50 takes place after the total propagation delay. FIG. 4A illustrates circuit components that may be utilized to form the initial delay stage 78A. The functionality of these components will be explained in further detail in FIG. 4D. However, the first intermediary delay stage 78B, the second intermediary delay stage 78C, and the final delay stage 78D are presumed to have the same components as the initial delay stage 78A.

In the oscillation mode, when the delay stages 78 are not receiving the codes 84, each delay stage 78A-78D is configured to invert the differential inputs 80 so that the differential outputs 82 have an inverse polarity of the differential inputs 80. However, each delay stage 78 has a delay stage propagation delay. The delay stage propagation delay determines the amount of time required by the delay stage 78 to generate the differential output 82 with the inverse polarity of the differential input 80.

Referring now to FIG. 4B and with continuing reference to FIG. 4A, FIG. 4B illustrates embodiments of the differential outputs 82A-82D which may be generated by the delay stages 78 during the oscillation mode. The final differential output 82D is the clock output 50 in FIG. 4A. The explanation of the functionality of the resettable VCO 74 of FIG. 4A begins at time t₁ in FIG. 4B immediately after a clock pulse 85 when the final differential output 82D has a low signal level. When the final differential output 82D has the low signal level, a top polarity of the final differential output 82D has a low signal level and a bottom polarity of the final differential output 82D has a high signal level (see FIG. 4A). Accordingly, the initial differential input 80A is received by the initial delay stage 78A such that a top polarity of the initial differential input 80A has a low signal level and a bottom polarity of the initial differential input 80A has a high signal level. As explained above, the initial delay stage 78A is configured to generate the initial differential output 82A with an inverse polarity of the initial differential input 80A. However, the initial delay stage 78A has an initial delay stage propagation delay 86A so that the initial differential output 82A does not settle as having the inverse polarity of the initial differential input 80A until time t₂.

With continuing reference to FIG. 4B, at time t₂, the initial differential output 82A has a high signal level. Thus, a top polarity of the initial differential output 82A has high signal level and a bottom polarity of the initial differential output 82A has a low voltage level. The first intermediary delay stage 78B is cross-coupled with the initial delay stage 78A. As a result, a top polarity of the first intermediary differential input 80B has the low signal level and a bottom polarity of the first intermediary differential input 80B has the high signal level at time t₂. The first intermediary delay stage 78B is also configured to generate the first intermediary differential output 82B as having an inverse polarity of the first intermediary differential input 80B. However, the first intermediary delay stage 78B has a first intermediary delay stage propagation delay 86B such that the first intermediary differential output 82B does not settle as having the inverse of the first intermediary differential input 80B until time t₃.

With continuing reference to FIG. 4B, at time t₃, the first intermediary differential output 82B has the high signal level and thus, a top polarity of the first intermediary differential output 82B has the high signal level while a bottom polarity of the first intermediary differential output 82B has the low signal level. The second intermediary delay stage 78C is cross-coupled to the first intermediary delay stage 78B. Thus, the top polarity of the second intermediary differential input 80C has the low signal level and a bottom polarity of the second intermediary differential input 80C has the high signal level at time t₃. The second intermediary delay stage 78C is also configured to generate the second intermediary differential output 82C with an inverse polarity of the second intermediary differential input 80C. However, the second intermediary delay stage 78C has a second intermediary delay stage propagation delay 86C so that the second intermediary differential output 82C does not settle as the inverse polarity of the second intermediary differential input 80C until time t₄.

With continuing reference to FIG. 4B, at time t₄, the second intermediary differential output 82C has the high signal level and thus, a top polarity of the second intermediary differential output 82C has the high signal level and a bottom polarity of the second intermediary differential output 82C has the low signal level. The final delay stage 78D is cross-coupled with the second intermediary delay stage 78C. As a result, a top polarity of the final differential input 80D has the low signal level and a bottom polarity of the final differential input 80D has the high signal level at time t₄. The final delay stage 78D is configured to generate the final differential output 82D with an inverse polarity of the final differential input 80D. However, the final delay stage 78D has a final delay stage propagation delay 86D so that the final differential output 82D does not settle as having the inverse polarity as having the inverse polarity of the final differential input 80D until time t₅.

With continuing reference to FIG. 4B, the final differential output 82D and thus, the clock output 50 has the high signal level at time t₅. As such, a top polarity of the final differential output 82D has the high signal level and a bottom polarity of the final differential output 82D has the low signal level at time t₅. The clock output 50 has thus been inverted to the high signal level after half of a clock period. Half of the clock period is about equal to the aggregation of the initial delay stage propagation delay 86A, the first intermediary delay stage propagation delay 86B, the second intermediary delay stage propagation delay 86C, and the final delay stage propagation delay 86D.

With continuing reference to FIG. 4B, the final differential output 82D is fed back to the initial delay stage 78A. Thus, at time t₅, the top polarity of the initial differential input 80A has the high signal level and the bottom polarity of the initial differential output 82A has the low signal level. As a result, after the initial delay stage propagation delay 86A, the initial differential output 82A inverts to the low signal level at time t₆. Thus, at time t₆, the top polarity of the initial differential output 82A has the low signal level and the bottom polarity of the final differential output 82D has the high signal level.

Due to cross coupling of the initial delay stage 78A and the first intermediary delay stage 78B, the top polarity of the first intermediary differential input 80B has the high signal level and the bottom polarity of the first intermediary differential input 80B has the low signal level at time t₆. After the first intermediary delay stage propagation delay 86B, the first intermediary differential output 82B inverts to the low signal level at time t₇. As a result, the top polarity of the first intermediary differential output 82B has the low signal level and the bottom polarity of the first intermediary differential output 82B has the high signal level at time t₇.

Due to cross coupling of the first intermediary delay stage 78B and the second intermediary delay stage 78C, the top polarity of the second intermediary differential input 80C has the high signal level and the bottom polarity of the second intermediary differential input 80C has the low signal level at time t₇. After the second intermediary delay stage propagation delay 86C, the second intermediary differential output 82C inverts to the low signal level at time t₈. As a result, the top polarity of the second intermediary differential output 82C has the low signal level and the bottom polarity of the second intermediary differential output 82C has the high signal level at time t₈.

Due to the cross coupling of the second intermediary delay stage 78C and the final delay stage 78D, the top polarity of the final differential input 80D has the high signal level and the bottom polarity of the final differential input 80D has the low signal level at time t₈. After the final delay stage propagation delay 86D, the final differential output 82D inverts to the low signal level at time t₉. As a result, the top polarity of the final differential output 82D has the low signal level and a bottom polarity of the final differential output 82D has the high signal level at time t₉. Thus, the clock output 50 is inverted back to low at time t₉ as it was at time t₁. The clock output 50 has thus been again inverted to low after another half of a clock period. This other half clock period is again about equal to the aggregation of the initial delay stage propagation delay 86A, the first intermediary delay stage propagation delay 86B, the second intermediary delay stage propagation delay 86C, and the final delay stage propagation delay 86D. The clock period is thus about twice the aggregation of the initial delay stage propagation delay 86A, the first intermediary delay stage propagation delay 86B, the second intermediary delay stage propagation delay 86C, and the final delay stage propagation delay 86D. The above described process repeats so long as the resettable VCO 74 is in the oscillation mode.

In the embodiment of the resettable VCO 74, the initial delay stage propagation delay 86A, the first intermediary delay stage propagation delay 86B, the second intermediary delay stage propagation delay 86C, and the final delay stage propagation delay 86D, are about the same and thus, are each equal to approximately one-eighth of a clock period. Alternative embodiments of the resettable VCO 74 may be configured so that the delay stage propagation delays 86A-86D have a designed difference. In any case, the combination of the delay stage propagation delays 86A-86D determine the temporal length of half of the clock period and thus, set the clock frequency of the differential outputs 82 and, as a result, the clock output 50. The delay stages 78 may be programmable so as to vary their delay stage propagation delay 86 thereby allowing for the clock frequency of the differential outputs 82 (and thus also, the clock output 50) to be varied.

Referring now to FIG. 4C and with continuing reference to FIG. 4A, FIG. 4C is an exemplary signal diagram illustrating an exemplary reset pulse 58 and various embodiments of the clock output (referred to individually in FIG. 4C as elements 50A-50F). As a result of the reset pulse 58, the resettable VCO 74 receives the phase control input 76 (shown in FIG. 3) as a gated phase control code. The gated phase control code is indicative of a phase setting for the clock phase of the clock output 50. The gated phase control code is received by the resettable VCO 74 shown in FIG. 4A as the first code 84A, the second code 84B, the third code 84C, and the fourth code 84D. When each of the delay stages 78 receives the codes 84, the resettable VCO 74 operates in the reset mode. Rather than providing the differential outputs 82 in accordance with the differential inputs 80 as in the oscillation mode, each delay stage 78 is configured to receive the corresponding code 84 of the phase control input 76 (shown in FIG. 3) during the reset mode and provide the corresponding differential output 82 based on the corresponding code 84.

Again as discussed above, the final differential output 82D (shown in FIG. 4B) is the clock output 50 (shown in FIG. 4A) in this embodiment for the resettable VCO 74. Thus, FIG. 4C illustrates various embodiments of the clock output 50 (and thus the final differential output 82D in FIG. 4B) as clock outputs 50A-50F. The clock output 50A is shown without any adjustment due to the reset mode and is simply provided as a reference for the other clock outputs 50B-50F. Each of the clock outputs 50B-50F have been adjusted in accordance with different exemplary phase settings indicated by the gated phase control code. In this embodiment, the phase setting indicated by the gated phase control code is a phase delay (referred to generically as element 88 and individually as elements 88A-88E in FIG. 4C). The resettable VCO 74 is configured to adjust the clock phase of the clock output 50 depending on the phase delay 88 indicated by the gated phase control code. The clock phase of the clock output 50 is adjusted by providing the phase delay 88 is response to release of the reset pulse 58.

Referring again to FIGS. 4A and 4C, the reset pulse 58 begins at a time tₐ when the clock outputs 50A-50F are at the low signal level. Thus, at time tₐ the top polarity of the clock output 50 (and thus the final differential output 82D shown in FIG. 4B) has the low signal level and the bottom polarity of the clock output 50 has the high signal level. In essence, the gated phase control code selects a point in the oscillation of the differential outputs 82A-82D (shown in FIG. 4B) so that the phase delay 88 is provided in response to release of the reset mode when the resettable VCO 74 is put back in the oscillation mode. The reset pulse 58 ends at time t_{b}. In response to release of the reset pulse 58, the phase delay 88 is provided based on the point of the oscillation selected by the particular embodiment of the gated phase control code during the reset mode.

To further explain the operation of the resettable VCO 74, the table below illustrates embodiments of the gated phase control code, the corresponding phase delay 88 indicated by that particular gated phase control code, and the phase adjustment provided by the corresponding phase delay 88 to the clock phase of the corresponding clock output 50 in FIG. 4C.

| Gated Phase | | |
|---|---|---|
| Control Code | Corresponding Phase Delay | Phase Adjustment |
| 00001111 | Phase Delay 88A = 0 of a clock | −⅛ of a clock period |
| | period | for clock output 50B |
| 00011110 | Phase Delay 88B = ⅛ of a | 0 of a clock period for |
| | clock period | clock output 50C |
| 00111100 | Phase Delay 88C = ¼ of a | ⅛ of a clock period |
| | clock period | for clock output 50D |
| 01111000 | Phase Delay 88D = ⅜ of a | ¼ of a clock period |
| | clock period | for clock output 50E |
| 11110000 | Phase Delay 88E = ½ of a | ⅜ of a clock period |
| | clock period | for clock output 50F |

The logical bit “1” in the gated phase control codes of the table above represent a high signal level, while the logical bit “0” of the gated phase control codes represents a low signal level. The clock output 50A shown in FIG. 4C is provided without any adjustments to the clock phase and is intended simply to provide a reference to help guide the explanation of the operation of the resettable VCO 74. Since the reset pulse 58 is indicative of edge detection in the data stream 36 (shown in FIG. 3), the reset pulse 58 serves as a reference point with regard to the data phase of the data stream 36. The reset mode allows for the clock phase of the clock output 50 to be adjusted in accordance with the gated phase control code, as shown by clock outputs 50B-50F in FIG. 4C.

Referring again to FIGS. 4A and 4C, the initial delay stage 78A is configured to receive the first code 84A as the first bit and the fifth bit of the gated phase control code. More specifically, a top polarity of the first code 84A is the first bit of the gated phase control code and a bottom polarity of the first code 84A is the fifth bit of the gated phase control code. In the reset mode, the initial delay stage 78A is configured to generate the initial differential output 82A as a reverse polarity of the first code 84A during the reset mode. For example, the top polarity of the first code 84A may be provided having the high signal level (i.e., the first bit of the first code is “1”) and the bottom polarity of the first code 84A may be provided having the low signal level (i.e., the fifth bit of the phase control code is “0”). In this case, the top polarity of the initial differential output 80B is generated so that the top polarity of the initial differential output 80B has the low signal level and the bottom polarity has the high signal level during the reset mode. However, the top polarity of the first code 84A may be provided having the low signal level (i.e., the first bit of the gated phase control code is “0”) and the bottom polarity of the first code 84A may be provided having the high signal level (i.e., the fifth bit of the gated phase control code is “1”). In this case, the initial delay stage 78A generates initial differential output 82A so that the top polarity of the initial differential output 82A has the high signal level and the bottom polarity of the initial differential output 82A has the low signal level.

The first intermediary delay stage 78B receives the second code 84B as the second bit and the sixth bit of the gated phase control code. More specifically, a top polarity of the second code 84B is the second bit of the gated phase control code while a bottom polarity of the second code 84B is the sixth bit of the gated phase control code. The first intermediary delay stage 78B is configured to generate the first intermediary differential output 82B as the reverse polarity of the second code 84B during the reset mode. For example, the top polarity of the second code 84B may be provided having the high signal level (i.e., the second bit of the gated phase control code is “1”) and the bottom polarity of the second code 84B may be provided having the low signal level (i.e., the sixth bit of the gated phase control code is “0”). In this case, the first intermediary delay stage 78B generates the first intermediary differential output 82B so that the top polarity of the first intermediary differential output 82B has low signal level and the bottom polarity has the high signal level. However, the top polarity of the second code 84B may be provided having the low signal level (i.e., the second bit of the gated phase control code is “0”) and the bottom polarity of the second code 84B may be provided having the high signal level (i.e., the sixth bit of the gated phase control code is “1”). In this case, the second intermediary differential output 82C is provided so that the top polarity of the second intermediary differential output 82C has the high signal level and the bottom polarity has the low signal level.

Next, the second intermediary delay stage 78C is configured to receive the third code 84C as the third bit of the gated phase control code and the seventh bit of the gated phase control code. More specifically, a top polarity of the third code 84C is the third bit of the gated phase control code and a bottom polarity of the third code 84C is the seventh bit of the gated phase control code. The second intermediary delay stage 78C is configured to generate the second intermediary differential output 82C as a reverse polarity of the third code 84C during the reset mode. For example, the top polarity of the third code 84C may be provided having the high signal level (i.e., the third bit of the gated phase control code is “1”) and the bottom polarity of the third code 84C may be provided having the low signal level (i.e., the seventh bit of the gated phase control code is “0”). In this case, the second intermediary delay stage 78C generates the second intermediary differential output 82C so that the top polarity of the second intermediary differential output 82C has the low signal level and the bottom polarity has the high signal level. However, the top polarity of the third code 84C may be provided having the low signal level (i.e., the third bit of the gated phase control code is “0”) and the bottom polarity of the third code 84C may be provided having the high signal level (i.e., the seventh bit of the gated phase control code is “1”). In this case, the second intermediary delay stage 78C generates the second intermediary differential output 82C so that the top polarity of the second intermediary differential output 82C has the high signal level and the bottom polarity of the second intermediary differential output 82C has the low signal level.

Finally, the final delay stage 78D is configured to receive the fourth code 84D as the fourth bit and the eighth bit of the gated phase control code. More specifically, a top polarity of the fourth code 84D is the fourth bit of the gated phase control code and a bottom polarity of the fourth code 84D is the eighth bit of the gated phase control code. The final delay stage 78D is configured to generate the final differential output 82D and thus, the clock output 50, as a reverse polarity of the fourth code 84D during the reset mode. For example, the top polarity of the fourth code 84D may be provided having the high signal level (i.e., the fourth bit of the gated phase control code is “1”) and the bottom polarity of the fourth code 84D may be provided having the low signal level (i.e., the eighth bit of the gated phase control code is “0”). In this case, the final delay stage 78D generates the final differential output 82D so that the top polarity of the final differential output 82D has the low signal level and the bottom polarity of the final differential output 82D has the high signal level. However, the top polarity of the fourth code 84D may be provided having the low signal level (i.e., the fourth bit of the gated phase control code is “0”) and the bottom polarity of the fourth code 84D may be provided having the high signal level (i.e., the eighth bit of the gated phase control code is “1”). In this case, the final delay stage 78D generates the final differential output 82D so that the top polarity of the final differential output 82D has the high signal level and the bottom polarity has the low signal level.

Without no adjustments to the clock phase by the gated phase control code, the clock output 50A shown in FIG. 4C demonstrates that a clock edge 90A of the clock output 50A occurs at time t_{c}. However, when the gated phase control code “00001111” is received during the reset pulse 58, the delay stages 78 generate the differential outputs 82 in the same manner as shown at time t₅ in FIG. 4B. Accordingly, upon release of the reset mode, an initial clock edge 90B of the clock output 50B follows the release of the reset mode after the phase delay 88A. The clock phase has thus been adjusted by time t_{b} minus time t_{c}. This means that, in this embodiment, the clock phase of the clock output 50B has been shifted up approximately one-eighth of the clock period. The gated phase control code “00001111” represents a phase delay 88A equaling zero. However, due to the relationship between the reset pulse 58 and the clock phase of the clock output 50B prior to the occurrence of the reset pulse 58, the phase adjustment to the clock phase of the clock output 50B is a shift upwards of one-eighth of the clock period. In other embodiments, the phase delay 88A of zero (and the other phase delays 88B-88E) may provide different phase adjustment depending on the temporal relationship between the clock phase and the reset pulse 58.

Next, when the gated phase control code is “00011110,” the delay stages 78 provide the differential outputs 82 in the same manner as shown at time t₄ in FIG. 4B. In response to release of the reset pulse 58, an initial clock edge 90C of the clock output 50C follows the release of the reset mode after the phase delay 88B. The phase delay 88B in this case is approximately equal to the final delay stage propagation delay 86D and is thus about one-eighth of the clock period. The initial clock edge 90C of the clock output 50C is provided at time t_{c} and thus the phase adjustment to the clock phase is equal to t_{c} minus t_{c}, which is zero. The phase delay 88B of one-eighth of the clock period thus provides a phase adjustment of zero in this embodiment.

With regard to the gated phase control code “00111100,” the delay stages 78 provide the differential outputs 82 in the same manner as shown at time t₃ in FIG. 4B. In response to release of the reset pulse 58, an initial clock edge 90D of the clock output 50D follows the release of the reset mode after the phase delay 88C. The phase delay 88C is approximately equal to the aggregation of the final delay stage propagation delay 86D and the second intermediary delay stage propagation delay 86C. This means that the phase delay 88C is about one-fourth of the clock period. The initial clock edge 90D of the clock output 50D is at time t_{d}. Accordingly, the phase adjustment to the clock phase is equal to t_{d}−t_{c}. This means the clock phase of the clock output 50D has been shifted down about one-eighth of the clock period. Thus, the phase delay 88C of one-fourth of the clock period shifts the clock phase of the clock output 50D down by one-eighth of the clock period in this embodiment.

Next, when the gated control code is “01111000,” the delay stages 78 provide the differential outputs 82 in the same manner as shown at time t₂ in FIG. 4B. In response to the release of the reset pulse 58, an initial clock edge 90E of the clock output 50E follows the release of the reset mode after the phase delay 88D. The phase delay 88D is thus approximately equal to an aggregation of the final delay stage propagation delay 86D, the second intermediary delay stage propagation delay 86C and the first intermediary delay stage propagation delay 86B, which is equal to three-eighths of the clock period. The initial clock edge 90E is at time tₑ. Accordingly, the phase adjustment of the clock output 50E is equal to tₑ minus t_{c} and the clock phase has been shifted down about one-quarter of the clock period. Thus, the phase delay 88D of three-eighths of the clock period shifts the clock phase of the clock output 50E down by one-quarter of the clock period.

With regards to the gated phase control code “11110000,” the delay stages 78 provide the differential outputs 82 in the same manner as shown at time t₁ in FIG. 4B. In response to the release of the reset pulse 58, an initial clock edge 90F of the clock output 50F follows the release of the reset mode after the phase delay 88E. The phase delay 88E is equal to an aggregation of the final delay stage propagation delay 86D, the second intermediary delay stage propagation delay 86C, the first intermediary delay stage propagation delay 86B, and the initial delay stage propagation delay 86A, which is approximately equal to half the clock period. The initial clock edge 90F of the clock output 50E occurs at time t_{f} and thus the phase adjustment is equal to t_{f} minus t_{c}. The phase delay 88E of half of the clock period has thus shifted down the clock phase of the clock output 50E by approximately three-eighths of the clock period.

As discussed above, embodiments of the resettable VCO 74 may have any number of delay stages 78. The example shown in FIG. 4A has four delay stages 78, but may have any number less or greater than four. The number of delay stages 78 simply controls the number of phase delays 88 that can be provided to phase shift the clock output 50.

FIG. 4D illustrates exemplary components that may be provided in one of the delay stages 78 shown in FIG. 4C. The delay stage 78 includes p-channel type field effect transistors (FETs) 92, 94, 96, 98, 100, 102. Additionally, the delay stage 78 has n-channel type FETs 104 106, 108, 110, 112 and 114. Also provided are inverter gates 116, 118, 120, and 122 along with a variable capacitive component 124. In this exemplary embodiment, a DC-voltage VDD is provided to the delay stage 78. The DC-voltage VDD provides the high voltage level. Another DC-voltage VSS is also provided to the delay stage 78. The DC-voltage VSS may be at the ground to provide the low voltage level.

The differential input 80 and the differential output 82 are differential signals. Accordingly, when the differential output 82 has the high signal level, the voltage level of the differential output is about at VDD. Thus, the top polarity of the differential output 82 is about at VDD and the bottom polarity of the differential output 82 is about at VSS. However, if the differential output has the low signal level, the differential output has a voltage level of −VDD. Thus, the top polarity of the differential output 82 is at VSS and the bottom polarity of the differential output 82 is at VDD. The same goes for the differential input 80.

In the oscillation mode, the code 84 is not received by the delay stage 78. Accordingly, terminals 126A, 126B are both low at about VSS. When terminals 126A, 126B both have the low signal level, FETs 112, 100, 102, and 114 are all switched off. The p-channel type FETs 94, 98 may be switched on if the p-channel type FETs 92, 96 are switched on. Similarly, the n-channel type FETs 104, 110 may be switched on when the n-channel type FETs 106, 108 are switched on. If a top polarity of the differential input 80 has the low signal level and a bottom polarity of the differential input 80 has the high signal level, the p-channel type FET 92 and the n-channel type FET 108 are switched on while the p-channel type FET 96 and the n-channel type FET 106 are switched off. In this case, the high voltage level VDD appears at node 128A and the low voltage level VSS appears at node 128B. However, the inverter gates 120, 122, and the variable capacitive component 124 form a memory cell and thus, the top polarity of the differential output 82 and the bottom polarity of the differential output 82 do not immediately appear at the high and low levels respectively. Instead, the variable capacitive component 124 must be charged accordingly and the delay stage propagation delay 86 of the delay stage 78 is provided by the variable capacitive component 124 (along with the switching transients of the other components). Thus, by varying the variable capacitate of the variable capacitive component 124, the clock frequency of the clock output 50 (shown in FIG. 3) may be controlled and varied. Once the variable capacitive component 124 is charged accordingly, the top polarity of the differential output 82 is at VDD while the bottom polarity of the differential output 82 is at VSS. As a result, the differential output 82 has the high signal level at the voltage level VDD.

If the top polarity of the differential input 80 has the high signal level and the bottom polarity of the differential input 80 has the low signal level during the oscillation mode, the p-channel type FET 92 and the n-channel type FET 108 are off while the n-channel type FET 106 and the p-channel type FET 96 are on. In this case, the low voltage level VSS is provided at node 128A while the high voltage level VDD is provided at node 128B. Again, the top polarity of the differential output 82 is not immediately low and the bottom polarity of the differential output 82 is not immediately high. Rather, the variable capacitive component 124 must be charged accordingly to provide the appropriate values for the differential output 82. Once the variable capacitive component 124 is charged accordingly, the top polarity of the differential output 82 is at VSS while the bottom polarity of the differential output 82 is at VDD. As a result, the differential output 82 has the low signal level at the voltage level −VDD.

However, in the reset mode, if the top polarity of the code 84 has the low signal level and the bottom polarity of the code 84 has the high signal level, the n-channel type FET 112 is off while the p-channel type FET 100 is on. Similarly in the reset mode, the p-channel type FET 102 is off while the n-channel type FET 114 is on. The p-channel type FET 94 may be switched on while the n-channel type FET 104 must be switched off. The p-channel type FET 98 must be switched off and the n-channel type FET 110 may be switched on. Thus, regardless of whether the top and bottom polarities of the differential input 80 are low or high, the high voltage level VDD is provided at node 128A and the low voltage level VSS is provided at node 128B. Once the variable capacitive component 124 is appropriately charged, the top polarity of the differential output 82 has the high signal level at VDD and the bottom polarity of the differential output 82 has the low signal level at VSS. As a result, the differential output 82 has the high signal level at the voltage level VDD.

In contrast, if the top polarity of the code 84 has the high signal level and the bottom polarity of the code 84 has the low signal level during the reset mode, the n-channel type FET 112 and the p-channel type FET 102 are switched on while the p-channel type FET 100 and the n-channel type FET 114 are switched off. Additionally, the p-channel type FET 94 and the n-channel type FET 110 must be switched off while the n-channel type FET 104 and the p-channel type FET 98 may be switched on. Accordingly, regardless of whether the top polarity of the differential input 80 has the low signal level or high and the bottom polarity of the differential input 80 has the low signal level or high, the low voltage level VSS is provided at the node 128A and the high voltage level VDD is provided at the node 128B. Once the variable capacitive component 124 is appropriately charged, the top polarity of the differential output 82 has the low signal level and the bottom polarity of the differential output 82 has the high signal level. As a result, the differential output 82 has the low signal level at the voltage level −VDD.

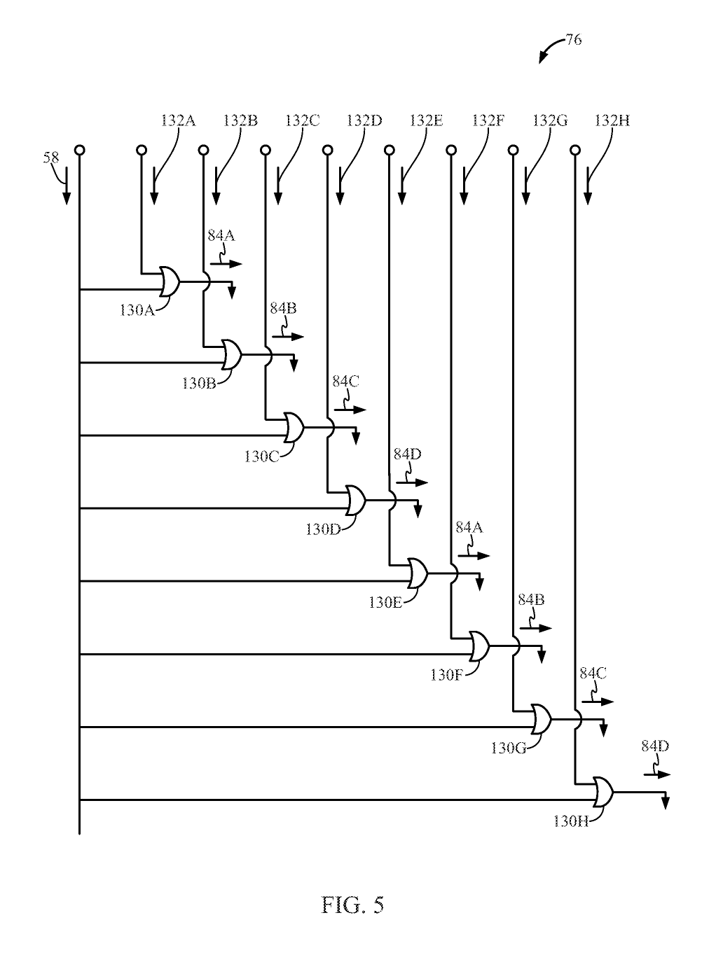

FIG. 5 illustrates a circuit diagram of the phase-shift setup circuit 70 that provides the phase control input 76 (shown in FIG. 3) in the reset mode. The phase-shift setup circuit 70 includes a plurality of nor-gates (referred to generically as element 130 and individually as elements 130A-130H). Each nor-gate 130 receives the reset pulse 58 and a bit (referred to generically as element 132 and individually as elements 132A-132H) of a preliminary phase control code. In this example, the reset pulse 58 is provided as a negative pulse that is provided low. Therefore, when no pulse is provided each of the nor-gates 130 receives a high input and there must generate a low output regardless of the bits 132 of the preliminary phase control code. However, when the reset pulse 58 is provided, the input from the reset pulse 58 has the low signal level. Each nor-gate 130 generates a bit of the gated phase control code as an output. This bit of the gated phase control code is inverted with respect to the bit 132 of the preliminary phase control code.

In this embodiment, the nor-gate 130A provides a top polarity of the first code 84A (i.e., the first bit of the gated phased control code) as an inversion of the first bit 132A of the preliminary phase control code. The nor-gate 130B provides a top polarity of the second code 84B (i.e., the second bit of the gated phased control code) as an inversion of the second bit 132B of the preliminary phase control code. The nor-gate 130C provides a top polarity of the third code 84C (i.e., the third bit of the gated phased control code) as an inversion of the third bit 132C of the preliminary phase control code. The nor-gate 130D provides a top polarity of the fourth code 84D (i.e., the fourth bit of the gated phased control code) as an inversion of the fourth bit 132D of the preliminary phase control code. The nor-gate 130E provides a bottom polarity of the first code 84A (i.e., the fifth bit of the gated phased control code) as an inversion of the fifth bit 132E of the preliminary phase control code. The nor-gate 130F provides the bottom polarity of the second code 84B (i.e., the sixth bit of the gated phased control code) as an inversion of the sixth bit 132F of the preliminary phase control code. The nor-gate 130G provides the bottom polarity of the third code 84C (i.e., the seventh bit of the gated phased control code) as an inversion of the seventh bit 132G of the preliminary phase control code. Finally, the nor-gate 130H provides the bottom polarity of the fourth code 84D (i.e., the eight bit of the gated phased control code) as an inversion of the eighth bit 132H of the preliminary phase control code.

The CDR circuits and resettable VCOs according to embodiments disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

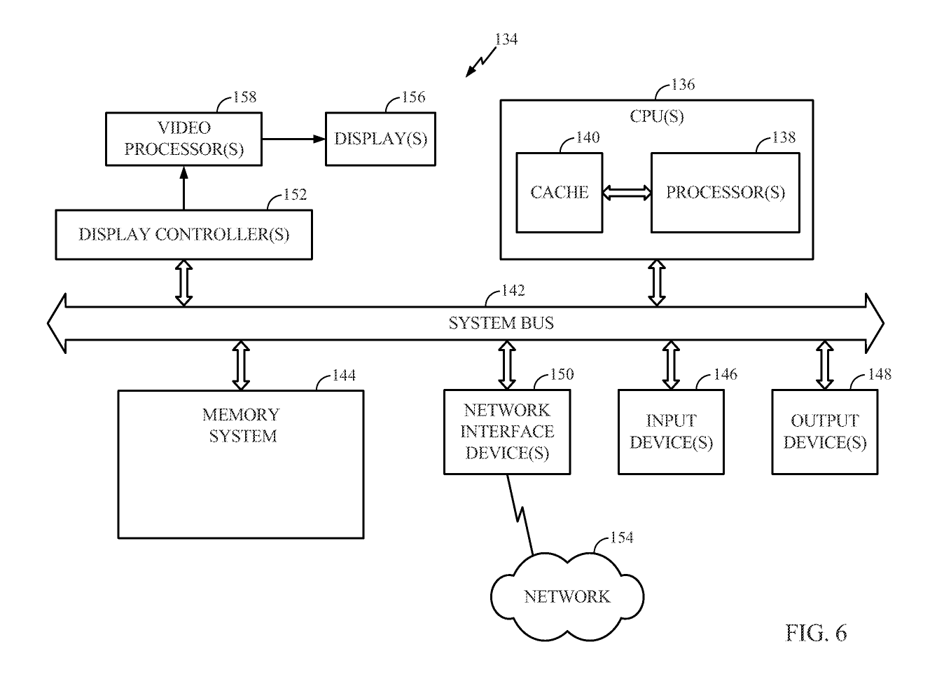

In this regard, FIG. 6 illustrates an example of a processor-based system 134 that can employ the CDR circuits disclosed herein. CDR circuits 34 and 66 shown in FIGS. 2 and 3 are not specifically shown but may generally be coupled to any particular component in the processor-based system 134, included in any of the components, in interfaces, or interfaced between any components of the processor-based system 134.

With continuing reference to FIG. 6, in this example, the processor-based system 134 includes one or more central processing units (CPUs) 136, each including one or more processors 138. The CPU(s) 136 may have cache memory 140 coupled to the processor(s) 138 for rapid access to temporarily stored data. The CPU(s) 136 is coupled to a system bus 142. The system bus 142 provides a path and may coordinate internal communications between the devices of the processor-based system 134. As is well known, the CPU(s) 136 communicates with these other devices by exchanging address, control, and data information over the system bus 142. For example, the CPU(s) 136 can communicate requests to a memory system 144. Although not illustrated in FIG. 6, multiple system buses 142 could be provided, wherein each system bus 142 constitutes a different fabric.

Other devices may be provided by the processor-based system 134 and connected to the system bus 142. As illustrated in FIG. 6, these devices can include other memory systems 144, one or more input devices 146, one or more output devices 148, one or more network interface devices 150, and one or more display controllers 152, as examples. The input device(s) 146 can include any type of input device, including but not limited to input keys, switches, voice processors, etc. The output device(s) 148 can include any type of output device, including but not limited to audio, video, other visual indicators, etc. The network interface device(s) 150 can be any devices configured to allow exchange of data to and from a network 154. The network 154 can be any type of network, including but not limited to a wired or wireless network, private or public network, a local area network (LAN), a wide local area network (WLAN), and the Internet. The network interface device(s) 150 can be configured to support any type of communication protocol desired. The memory system 144 can include one or more memory units.

The CPU 136 may also be configured to access the display controller(s) 152 over the system bus 142 to control information sent to one or more displays 156. The display controller(s) 152 sends information to the display(s) 156 to be displayed via one or more video processors 158, which process the information to be displayed into a format suitable for the display(s) 156. The display(s) 156 can include any type of display, including but not limited to a cathode ray tube (CRT), a liquid crystal display (LCD), a plasma display, etc.

Those of skill in the art would further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The CDR circuits and resettable VCOs herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may also be implemented or performed with a processor, a DSP, an Application Specific Integrated Circuit (ASIC), an FPGA or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art would also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A resettable voltage controlled oscillator (VCO) for a clock and data recovery circuit, the resettable VCO configured to:
generate a clock output having a clock phase;
receive a phase control input indicative of a phase setting for the clock phase; and
adjust the clock phase of the clock output based on the phase control input as a result of edge detection in a data stream.

2. The resettable VCO of claim 1, wherein the phase control input comprises a phase control code indicative of the phase setting for the clock phase.

3. The resettable VCO of claim 1, wherein the phase control input comprises a gated phase control code indicative of the phase setting for the clock phase and gated by a reset pulse indicative of edge detection in the data stream.

4. The resettable VCO of claim 3, wherein the phase setting indicated by the gated phase control code represents a phase delay.

5. The resettable VCO of claim 4, wherein the resettable VCO is further configured to adjust the clock phase of the clock output by providing the phase delay in response to release of the reset pulse.

6. The resettable VCO of claim 1, further configured to generate the control output having a clock frequency based on a bit rate of the data stream.

7. The resettable VCO of claim 1, further comprising a plurality of delay stages configured to generate the clock output.

8. The resettable VCO of claim 7, wherein the plurality of delay stages are programmable in an oscillation mode and a reset mode.

9. The resettable VCO of claim 8, wherein the plurality of delay stages comprise:
an initial delay stage configured to receive the clock output as the initial differential input and generate an initial differential output; and
a final delay stage configured to receive a final differential input based on the initial differential output and generate the clock output.

10. The resettable VCO of claim 9, further comprising at least one intermediary delay stage disposed between the initial delay stage and the final delay stage, the at least one intermediary delay stage configured to receive at least one intermediary differential input and generate at least one intermediary differential output.

11. The resettable VCO of claim 9, wherein in an oscillation mode:
the initial delay stage is configured to generate the initial differential output having an inverse polarity of the initial differential input; and
the final delay stage is configured to receive the final differential input and generate the clock output having an inverse polarity of the final differential input.

12. The resettable VCO of claim 9 configured to operate in the oscillation mode when not receiving the phase control input.

13. The resettable VCO of claim 9, wherein in a reset mode:
the initial delay stage is configured to generate the initial differential output as a reverse polarity of a first code of the phase control input; and
the final delay stage is configured to generate the clock output as a reverse polarity of a second code of the phase control input.

14. The resettable VCO of claim 7, wherein
during a reset mode, each of the plurality of delay stages is configured to:
receive a corresponding code of the phase control input gated by a reset pulse;
provide a corresponding differential output based on the corresponding code; and
wherein the clock output is comprised of one of the differential outputs such that, upon release of the reset mode, an initial edge of the clock output follows the release of the reset mode after the phase delay.

15. The resettable VCO of claim 1 integrated into a semiconductor die.

16. The resettable VCO of claim 1 included in a device selected from a group consisting of a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

17. A resettable voltage controlled oscillator (VCO) for a clock and data recovery circuit, the resettable VCO comprising:
means for generating a clock output having a clock phase;
means for receiving a phase control input indicative of a phase setting for the clock phase; and
means for adjusting the clock phase of the clock output based on the phase control input as a result of edge detection in the data stream.

18. A method for generating a clock output from a data stream in a clock and data recovery circuit, comprising:
generating a clock output having a clock phase;
receiving a phase control input indicative of a phase setting for the clock phase; and
adjusting the clock phase of the clock output based on the phase control input as a result of edge detection in a data stream.

19. The method of claim 18, wherein receiving the phase control input comprises receiving a phase control code indicative of the phase setting for the clock phase.

20. The method of claim 18, further comprising gating a preliminary phase control input with a reset pulse indicative of the edge detection in the data stream to generate the phase control input.

21. The method of claim 18, further comprising providing the clock output so that a sampler samples the data stream based on the clock output.

22. A computer-readable medium having stored thereon computer executable instructions to cause a processor-based resettable voltage controlled oscillator to:
generate a clock output having a clock phase;
receive a phase control input indicative of a phase setting for the clock phase; and
adjust the clock phase of the clock output based on the phase control input as a result of edge detection in a data stream.

23. A clock and data recovery circuit, comprising:
a sampler configured to receive a data stream in a data path and sample the data stream based on a clock output;
an edge detector configured to receive the data stream and generate a reset pulse upon detection of an edge in the data stream;
a resettable voltage controlled oscillator (VCO) configured to:
generate the clock output having a clock phase;
receive a phase control input indicative of a phase setting for the clock phase; and
adjust the clock phase of the clock output based on the phase control input as a result of the reset pulse.

24. The clock and data recovery circuit of claim 23 not including a tunable delay circuit in the data path to adjust a phase of the data stream.

25. The clock and data recovery circuit of claim 23, further comprising a clock buffer configured to receive the clock output and provide a buffered clock output to the sampler.

26. The clock and data recovery circuit of claim 23, wherein the clock path further comprises a phase-shift set up circuit configured to generate the phase control input in response to the reset pulse.
